(19) United States
(12) Patent Application Publication
(10) Pub. No.: US 2008/0184799 A1
(43) Pub. Date: Aug. 7, 2008

(54) Device With A Sensor Arrangement

(75) Inventors: Kim Phan Le, Eindhoven (NL); Hans Van Zon, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/911,669

(22) PCT Filed: Apr. 13, 2006
(86) PCT No.: PCT/IB06/51162

§ 371 Date: Oct. 16, 2007

(30) Foreign Application Priority Data
Apr. 22, 2005 (EP) 05103291.0

(51) Int. Cl. G01P 15/11

(52) U.S. Cl. 73/514.31

(57) ABSTRACT

Devices (40) are provided with sensor arrangements (41) comprising field generators (42) for generating magnetic fields, field detectors (43) comprising magnetic field dependent elements (51-58) for detecting components of the magnetic fields in planes of the elements (51-58), and movable objects (44) for, in response to accelerations of the movable objects (44) parallel to the planes, changing the components of the magnetic fields. Length axes of the magnetic field dependent elements (51-58) make angles between minus 80 degrees and plus 80 degrees with the components to be detected. Means for forcing the movable objects (44) into rest positions comprise elastic material (59) or fixed objects (46) whereby one of the objects (44,46) comprises the field generator (42) and the other comprises magnetic material or a further field generator (50).

The invention relates to a device with a sensor arrangement, and also relates to a sensor arrangement, and to a sensing method.

Examples of such a device are portable pc's and small handheld electronic devices such as mobile phones, personal digital assistants, digital camera's and global positioning system devices.

A prior art device is known from U.S. Pat. No. 6,131,457, which discloses an acceleration sensor comprising a magnetic body mounted to a vibrator having three-dimensional freedom and comprising four magneto-resistive elements. These four magneto-resistive elements detect components of the magnetic field originating from the magnetic body. A difference in output voltage between two magneto-resistive elements positioned along the X-axis indicates an acceleration in the X-direction, and a difference in output voltage between two magneto-resistive elements positioned along the Y-axis indicates an acceleration in the Y-direction. An aggregate sum of the output voltages of all magneto-resistive elements indicates an acceleration in the Z-direction.

The known acceleration sensor is disadvantageous, inter alia, owing to the fact that it requires a biasing magnetic field in addition to the magnetic field originating from the magnetic body to function properly. This additional biasing magnetic field improves the sensitivity and the linearity of the acceleration sensor.

It is an object of the invention, inter alia, to provide a device comprising a sensor arrangement which can detect an acceleration in a plane of the elements without requiring an additional biasing magnetic field to function properly.

Further objects of the invention are, inter alia, to provide a sensor arrangement which can detect an acceleration in a plane of the elements without requiring an additional biasing magnetic field to function properly and a sensing method which can detect an acceleration in a plane of the elements without requiring an additional biasing magnetic field to function properly.

The device according to the invention comprises a sensor arrangement comprising:

a field generator for generating at least a part of a magnetic field,

a field detector comprising magnetic field dependent elements for detecting components of the magnetic field in a plane of the magnetic field dependent elements, and

a movable object for, in response to an acceleration of the movable object, changing the components of the magnetic field,

a length axis of a specific magnetic field dependent element for detecting a specific component of the magnetic field making an angle between minus 80 degrees and plus 80 degrees with this specific component.

By introducing a field detector comprising at least two magnetic field dependent elements, such as magneto-resistive elements, which are elements of which a resistance value depends on a strength and on a direction of a magnetic field in which the elements are located, and by giving an angle situated between, on the one hand, a length axis of a specific magneto-resistive element for detecting a specific component of the magnetic field in a plane of the magneto-resistive elements and, on the other hand, this specific component, a value between minus 80 degrees and plus 80 degrees, the acceleration sensor has a good performance without an additional biasing magnetic field needing to be used. In U.S. Pat. No. 6,131,457, the length axis of the specific magnetic field dependent element for detecting the specific component of the magnetic field is perpendicular to this specific component. According to the invention, this perpendicularity, which perpendicularity at first sight seems to be a logical solution, is to be avoided.

The device according to the invention is further advantageous, inter alia, in that the acceleration sensor has a good sensitivity and a good linearity without an additional biasing magnetic field needing to be used. An acceleration can be a linear acceleration, an angular acceleration for detecting a rotation of the sensor arrangement and/or a gravity acceleration for detecting a tilt of the sensor arrangement. The acceleration may be a 1-dimensional or a 2-dimensional acceleration for example parallel to the plane of the magnetic field dependent elements.

In the device according to the invention, the field generator comprises a magnetic axis that is non-parallel to the plane of the magnetic field dependent elements. Other prior art devices than the one known from U.S. Pat. No. 6,131,457 and comprising field generators with magnetic axes that are parallel to the plane of the magnetic field dependent elements are therefore completely different from the device according to the invention. Preferably, in the device according to the invention, the field generator comprises a magnetic axis that makes an angle between plus 20 degrees and plus 160 degrees with the plane of the magnetic field dependent elements, further preferably, this angle is between plus 45 degrees and plus 135 degrees, yet further preferably this angle is substantially perpendicular to the plane, i.e. between 70 degrees and 110 degrees.

An embodiment of the device according to the invention is defined by a length axis of the specific magnetic field dependent element making an angle of substantially zero degree with the specific component for a rest position of the movable object, the specific magnetic field dependent element comprising Barberpole strips. This acceleration sensor has an improved sensitivity and an improved linearity, at the cost of a higher power consumption resulting from the specific magnetic field dependent element having a decreased resistance value when being provided with Barberpole strips. An angle of substantially zero degree corresponds with an angle between minus 20 degrees and plus 20 degrees, preferably zero degree. The Barberpole strips are usually oriented at +45 degrees with respect to the length axis of the specific magnetic field dependent element, without excluding other orientations.

An embodiment of the device according to the invention is defined by a length axis of the specific magnetic field dependent element making an angle of substantially 45 degrees with a direction of a magnetization of the specific magnetic field dependent element for a rest position of the movable object and for a given strength of the magnetic field. This acceleration sensor has an improved sensitivity and an improved linearity without Barberpole strips being used. An angle of substantially 45 degrees corresponds with an angle between 25 degrees and 65 degrees, preferably 45 degrees. At 45 degrees, the sensor arrangement has a maximum linearity and a maximum sensitivity.

An embodiment of the device according to the invention is defined by the sensor arrangement further comprising:

means for forcing the movable object into a rest position.

Such means allow to stabilize the position of the movable object at a given acceleration and allow two or more accelerations to be detected without needing to reset the sensor arrangement after each detection.

An embodiment of the device according to the invention is defined by the means comprising elastic material for, at least in case of the movable object being in a non-rest position, extending at least one force on the movable object in at least one direction parallel to the plane. Such elastic material prevents the need to use loosely moving parts.

An embodiment of the device according to the invention is defined by the movable object comprising the field generator. This embodiment is advantageous in that it can be made compact.

An embodiment of the device according to the invention is defined by the means comprising a fixed object, one of the objects comprising the field generator and the other object comprising magnetic material. In case the movable object comprises the field generator such as a magnet, the fixed object might comprise the magnetic material. In case the movable object comprises the magnetic material, the fixed object might comprise the field generator such as a magnet. In both cases, the magnet and the magnetic material might attract each other. Preferably, the magnetic material comprises soft magnetic material to prevent magnetic hysteretic effects. Further preferably, one or more flux closure parts partly surrounding the one or more objects might be introduced to make the sensor arrangement less sensitive to external fields and to reduce the stray fields of the magnet emitting to outer sides of the sensor arrangement.

An embodiment of the device according to the invention is defined by the movable object being in the form of a sphere located in a cavity. Such a cavity allows the spherical object to return to its rest position even after extreme accelerations and extreme impacts. The maximum size of the cavity depends on the strength of the attraction between both objects. Usually, the height of the cavity in the Z-direction could be for example 101% or 102% of the diameter of the spherical object. The width in the X-direction and the depth in the Y-direction could be for example 110% or 120% of this diameter, without excluding further sizes.

An embodiment of the device according to the invention is defined by the cavity comprising a liquid. Such liquid increases a damping effect and protects the spherical object against oxidation.

An embodiment of the device according to the invention is defined by the cavity comprising an inlet and an outlet. Such a sensor arrangement can be used as a wind sensor or a gas flow sensor.

An embodiment of the device according to the invention is defined by the movable object being coupled to a joystick. Such a sensor arrangement can be used not only to detect accelerations but also to detect joystick movements (position changes).

An embodiment of the device according to the invention is defined by the sensor arrangement further comprising:

a further movable object for, in response to an external force, moving the movable object. This further movable object takes the place of a joystick and allows the sensor arrangement to be used not only to detect accelerations but also to detect movements (position changes) of the further movable object.

An embodiment of the device according to the invention is defined by the sensor arrangement being an external force detector. Such a sensor arrangement can be used as a force sensor to detect intensity of the external force.

An embodiment of the device according to the invention is defined by the other object comprising the magnetic material being a further field generator for generating at least a further part of the magnetic field. The field generator and the further field generator for example each comprise a magnet, both magnets preferably having aligned magnetic axes for optimal efficiency.

Embodiments of the sensor arrangement according to the invention and of the method according to the invention correspond with the embodiments of the device according to the invention.

The invention is based upon an insight, inter alia, that the prior art device is disadvantageous owing to the fact that it requires an additional biasing magnetic field for improving the sensitivity and the linearity of the acceleration sensor, and is based upon a basic idea, inter alia, that the prior art magnetic field dependent elements are to be turned such that their length axes make angles between minus 80 degrees and plus 80 degrees with the components of the magnetic field to be detected.

The invention solves the problem, inter alia, to provide a device comprising a sensor arrangement which can detect an acceleration in a plane of the elements without requiring an additional biasing magnetic field to function properly, and is further advantageous, inter alia, in that the acceleration sensor has a good sensitivity and a good linearity without an additional biasing magnetic field needing to be used.

These and other aspects of the invention will be apparent from and elucidated with reference to the embodiments(s) described hereinafter.

In the drawings:

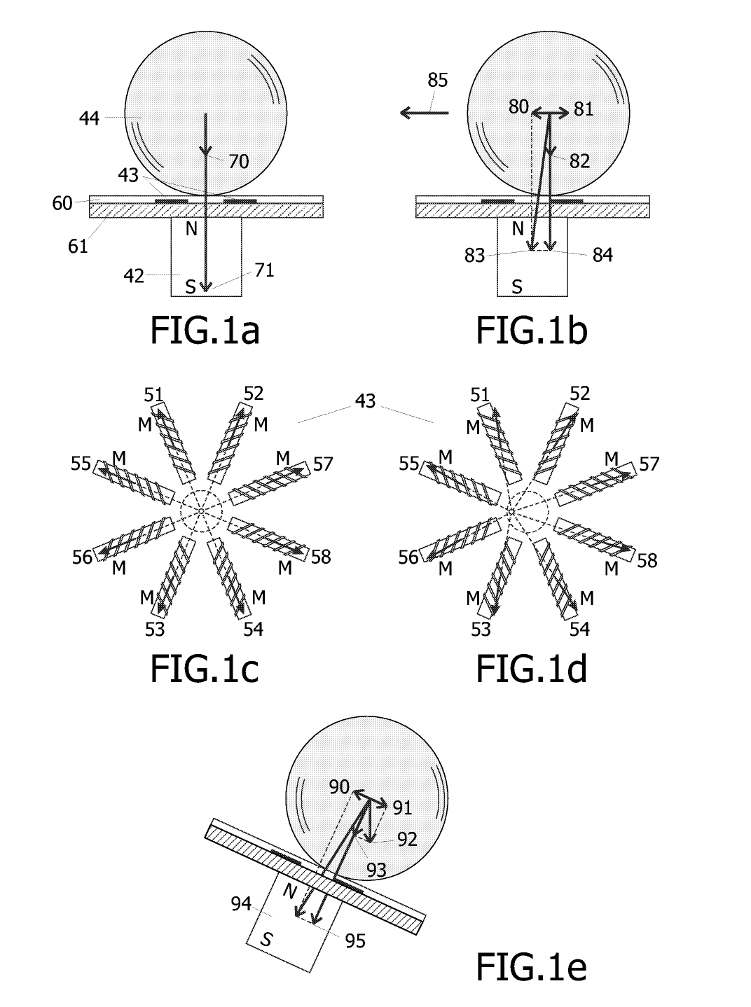

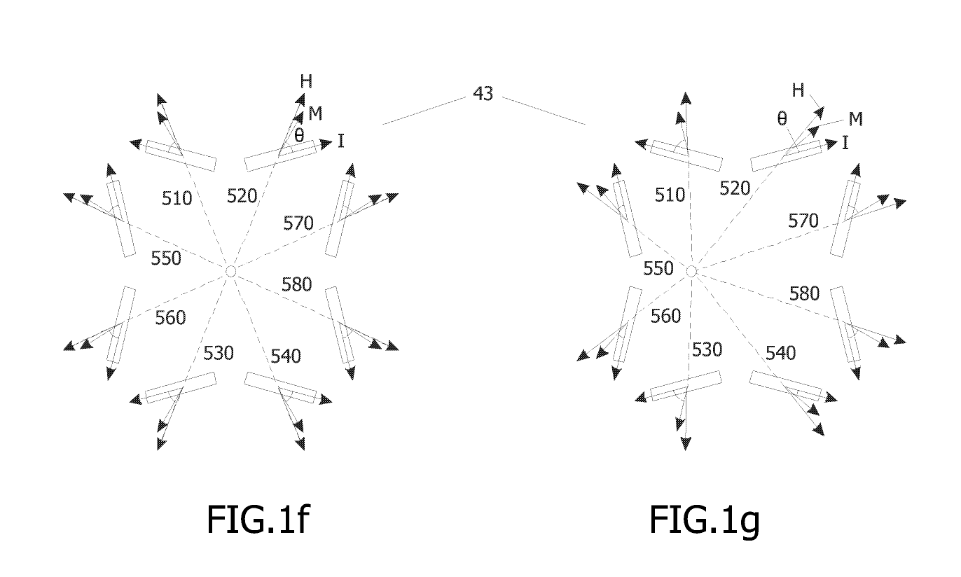

FIGS. 1a-g show diagrammatically a functionality of a sensor arrangement according to the invention comprising a movable object, a field generator and a field detector located in between;

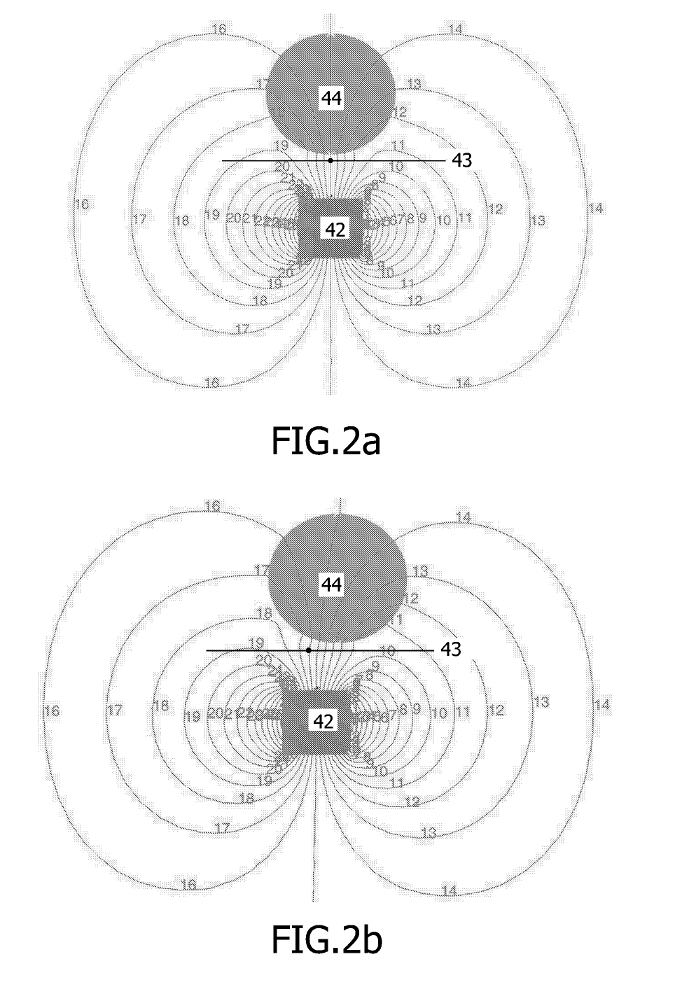

FIGS. 2a-b show magnetic field lines in the sensor arrangement according to the invention;

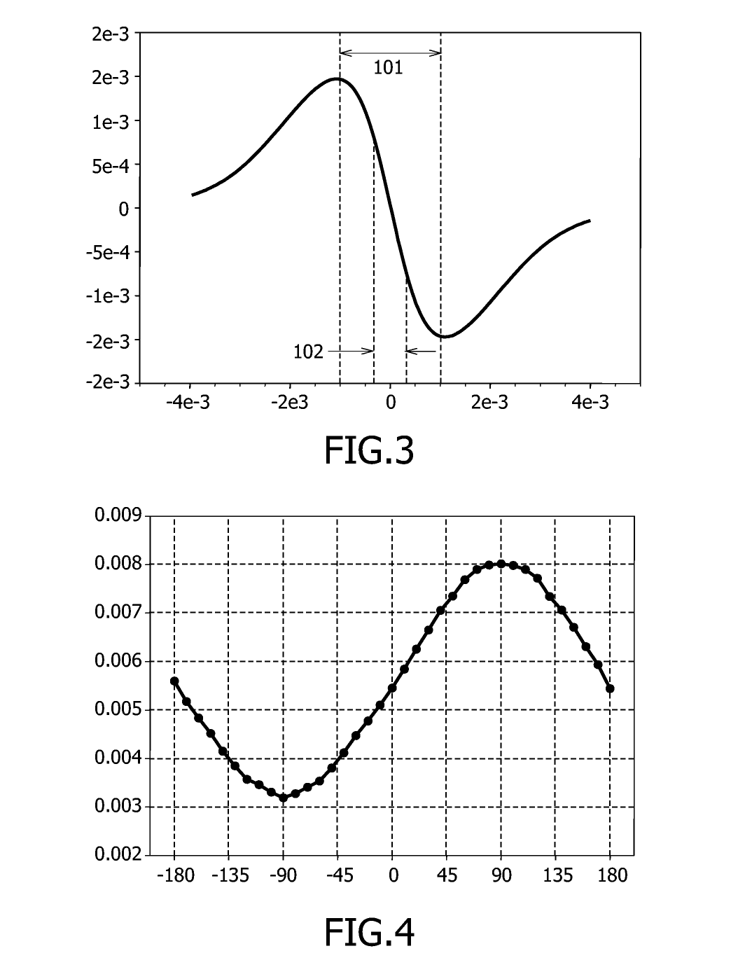

FIG. 3 shows a component of a magnetic force in a plane of the field detector and exerted on the movable object versus a position of the movable object;

FIG. 4 shows data of a tilt measurement with the sensor arrangement according to the invention;

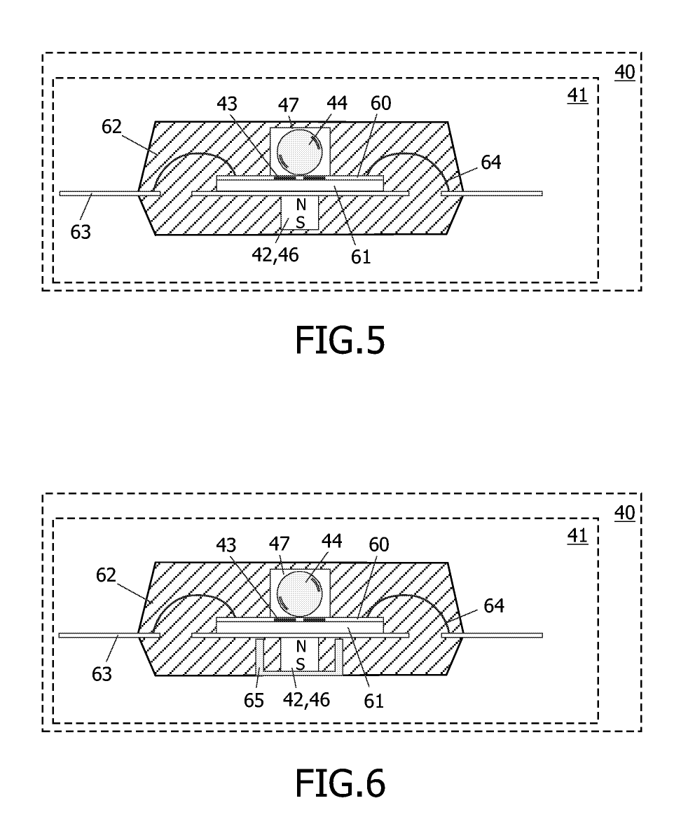

FIG. 5 shows a first device according to the invention comprising a first sensor arrangement according to the invention in cross section;

FIG. 6 shows a second device according to the invention comprising a second sensor arrangement according to the invention in cross section;

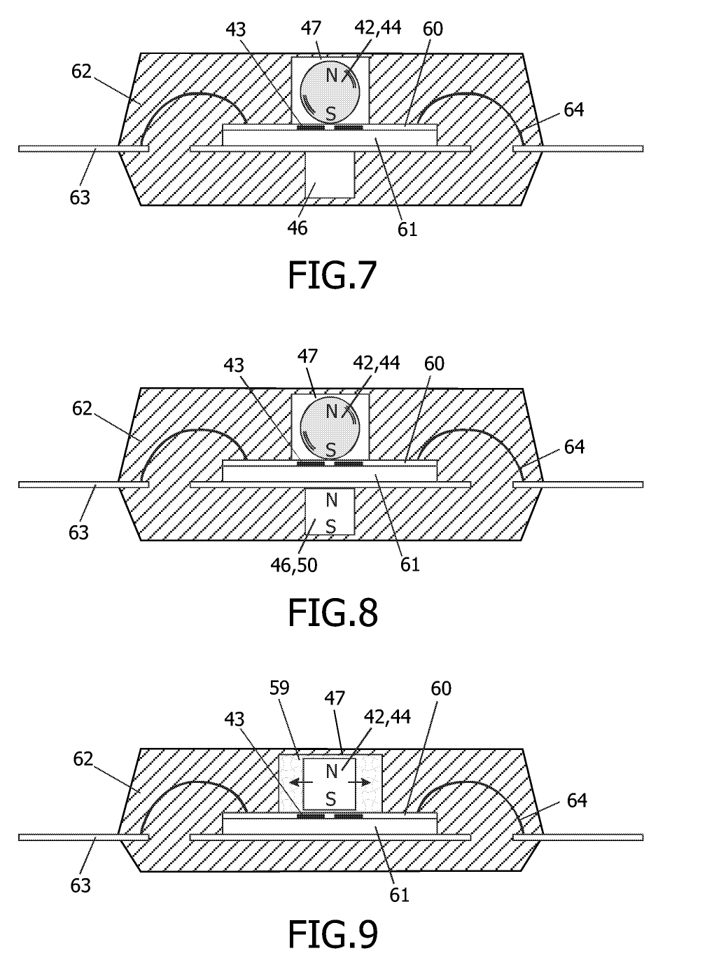

FIG. 7 shows a third sensor arrangement according to the invention in cross section;

FIG. 8 shows a fourth sensor arrangement according to the invention in cross section;

FIG. 9 shows a fifth sensor arrangement according to the invention in cross section;

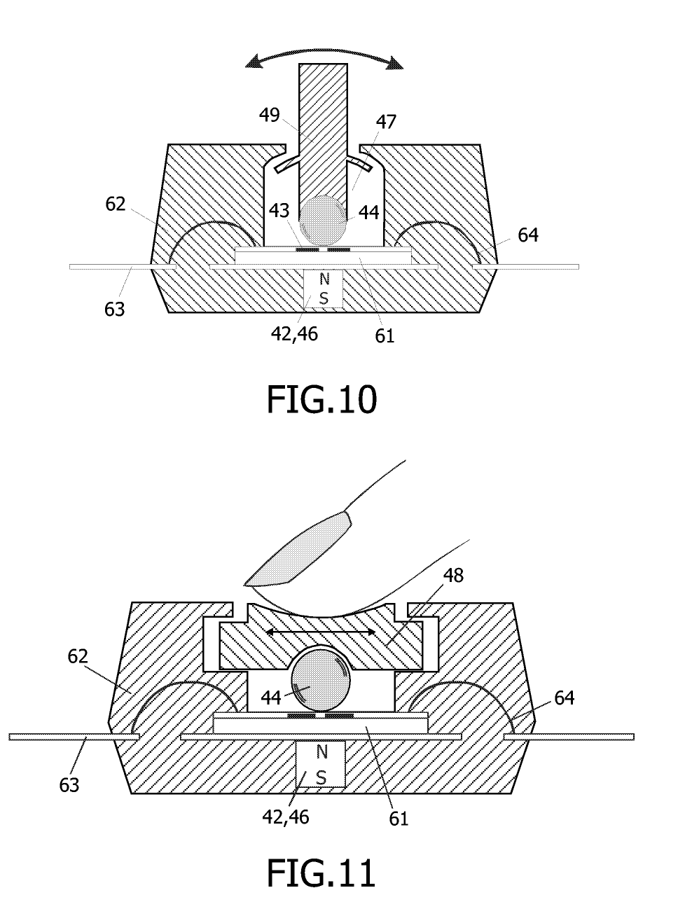

FIG. 10 shows a sixth sensor arrangement according to the invention in cross section;

FIG. 11 shows a seventh sensor arrangement according to the invention in cross section;

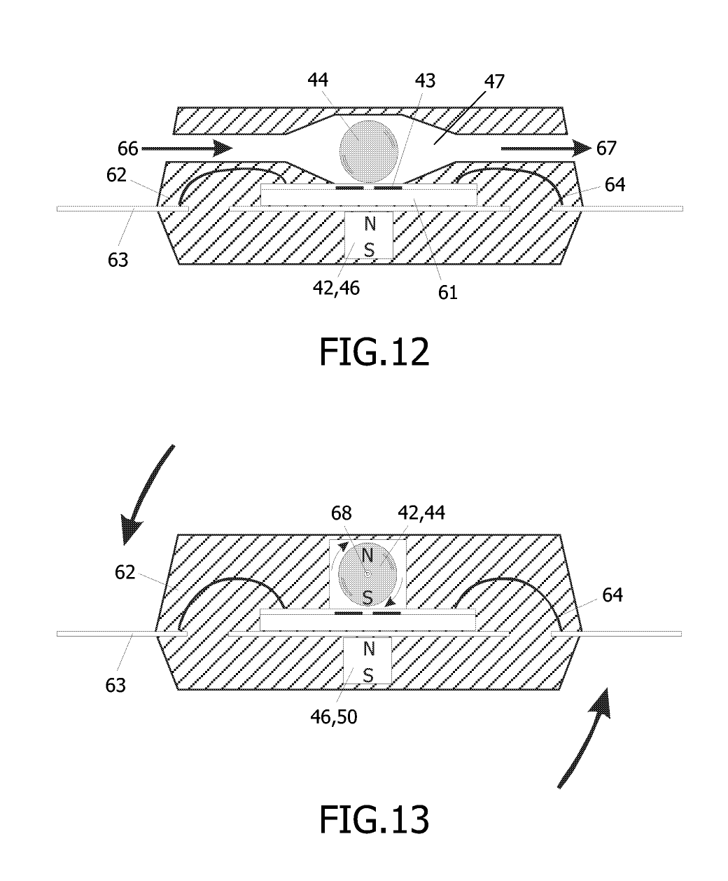

FIG. 12 shows an eighth sensor arrangement according to the invention in cross section; and

FIG. 13 shows a ninth sensor arrangement according to the invention in cross section.

The functionality of a sensor arrangement according to the invention is shown in FIG. 1(a)-(g). The sensor arrangement according to the invention comprises a movable object 44 in the form of a sphere or a spherical object and made of magnetically conducting material, a field generator 42 in the form of a permanent magnet and a field detector 43 located in between. The permanent magnet generates a magnetic field. The field detector 43 which comprises two or more magnetic field dependent elements such as for example magneto-resistive elements is located under a protection layer 60 on a substrate 61. In FIG. 1(a) the sensor arrangement is in a rest position, i.e. the plane of the elements is in a horizontal position and the sensor arrangement is not in acceleration. The magnetic force indicated by an arrow 71 induced by the permanent magnet firmly attaches the spherical object to the protection layer 60. In this (horizontal) rest position (no acceleration), the center of the spherical object is automatically aligned to the center of the permanent magnet. The gravity force indicated by an arrow 70 and the magnetic force indicated by the arrow 71 and exerted on the spherical object are aligned along a vertical direction.

In FIG. 1(c), the field detector 43 is shown in greater detail. This field detector 43 comprises eight magnetic field dependent elements 51-58. Four elements 51-54 form part of a first bridge (Y) and detect an acceleration in a first horizontal direction (X), and four elements 55-58 form part of a second bridge (X) and detect an acceleration in a second horizontal direction (Y). In the (horizontal) rest position, a center of a radial component of the magnetic field, which radial component is situated in a plane of the field detector 43 (in other words in a plane of the eight elements 51-58), is located at a center of the elements 51-58 of the field detector 43, as shown in FIG. 1(c). As a result, no signal is observed at the outputs of the two (for example Wheatstone) bridges. FIG. 2A shows the simulated field lines in this case.

In FIG. 1(b) the sensor arrangement is no longer in a (horizontal) rest position, owing to the fact that an acceleration indicated by an arrow 85 has occurred. A fictitious force indicated by an arrow 81 is exerted on the spherical object in a direction opposite to the acceleration direction and pulls the spherical object out of the center (the spherical object moves by rolling). In this position, the magnetic force indicated by an arrow 83 is acting on the spherical object. This magnetic force indicated by the arrow 83 is not vertical anymore but is slightly tilted towards (approximately) the center of the permanent magnet. This magnetic force indicated by the arrow 83 can be decomposed into two components, a perpendicular component indicated by an arrow 84 that together with the gravity force indicated by an arrow 82 keeps the spherical object attached to the protection layer 60 and a radial component indicated by an arrow 80 that tries to pull the spherical object back to the center of the sensor arrangement.

The radial component indicated by the arrow 80 increases as the displacement increases within a certain allowed displacement range. Therefore the fictitious force indicated by the arrow 81 is finally counterbalanced by the radial component that makes the spherical object settle in a new stable position. The displacement of the spherical object from the center is related to the strength of the fictitious force indicated by the arrow 81 and thus to the acceleration. In the new position, the magnetic symmetry of the system is broken, resulting in a displacement of the center of the radial component of the magnetic field, as shown in FIG. 1(d). This displacement (X) can be measured by the sensors of the bridge (Y). In FIG. 2B, the simulated field lines for this case are shown, when the spherical object is displaced 300 μm from the center of the bridge. The center of the radial component is displaced 185 μm away from the center of the sensor arrangement, in a direction opposite to that of the displacement of the spherical object. In a more general case, the acceleration in any direction in the plane of the sensor (i.e. the magnitude and direction of the acceleration) can be determined from the signals of both bridges (X,Y). Further below, the field detector 43 is further discussed, also in view of FIG. 1(e)-(g).

FIG. 3 shows a component of a magnetic force in a plane of the field detector 43 and exerted on the movable object 44 versus a position of the movable object 44 (Newton versus meter). At the center (i.e. X=0), the force is zero. When the spherical object moves in either direction (+X or −X), there exists a force trying to pull the spherical object back to the center. When the position of the spherical object is within the allowed range 101, as indicated in the graph, the magnitude of the radial component indicated by the arrow 80 increases with increasing displacement. Therefore a stable balance between the radial component indicated by the arrow 80 and the fictitious force indicated by the arrow 81 can always be found when the sensor is accelerated within a range such that the displacement of the spherical object is within the allowed range 101. If the spherical object is forced to move outside the allowed range 101, the forces cannot be balanced in a stable state anymore. Consequently the permanent magnet looses its grip on the spherical object and the spherical object may fall out if there is no fixing part to stop it. There is a smaller range 102 within which the curve is substantially linear. Ideally the sensor arrangement should be designed in such a way that its working range is within this linear range.

From calculations it can be derived that the radial component indicated by the arrow 80 and the perpendicular component indicated by the arrow 84 increase with increasing the size of the spherical object and the strength of the permanent magnet and that both components do not depend significantly on the magnetic susceptibility of the spherical object.

Gravity is a special case of acceleration. Therefore the sensor arrangement can also be used as a tilt (inclination) sensor arrangement. To measure the pure influence of gravity in a tilt measurement, the measurement should be performed when the sensor arrangement is not in acceleration. FIG. 1(e) sketches the side-view of the sensor arrangement in a tilt measurement. In this case, the gravity force indicated by an arrow 92 can be decomposed into two components, a perpendicular component indicated by an arrow 93 perpendicular to the plane of the elements and a parallel component indicated by an arrow 91 parallel to plane. Similar to the acceleration measurement case, the parallel component pulls the spherical object out of the center, which is counterbalanced by a radial component (of the magnetic field) indicated by an arrow 90 that tries to pull the spherical object back to the center. Because the signals in bridges X and Y are linearly dependent on the displacement of the spherical object, thus on the parallel components of the force caused by acceleration or gravity, the signals are sine functions of the tilt angles, signal (X,Y)˜arrow 91=arrow 92 sin(α_{X,Y}), where α_{X} and α_{Y} are the tilt angles projected in X or Y direction, respectively. In this way the tilt angles in X and Y directions (pitch and roll) can be determined from the signals of the bridges (X,Y). FIG. 4 shows data of a tilt measurement with the sensor arrangement according to the invention (Volt versus degrees). Dimensions and parameters of the sensor arrangement are similar to those used in the simulations shown earlier. The sensor arrangement has been rotated around the Y-direction while the signal in the X-direction was recorded. A similar behavior of signal in the Y-direction can also be measured when the sensor arrangement is rotated around the X-direction.

A first device 40 according to the invention comprising a first sensor arrangement 41 according to the invention is shown in FIG. 5 in cross section. The movable object 44 in the form of a sphere made of magnetic material is located in a cavity 47 mounted on the protection layer 60 which covers the field detector 43. This protection layer 60 is located on the substrate 61, which substrate 61 is located on a leadframe 63. Bondwires 64 couple the field detector 43 to the outer world. Below the leadframe 63, a fixed object 46 comprising a field generator 42 in the form of a magnet is fixed to the leadframe 63. The cavity 47, the protection layer 60, the substrate 61 and the fixed object 46 form part of a package 62.

The cavity 47 has to be just large enough to allow the spherical object to roll within a working range. The ceiling of the cavity can be very close (but not in contact) to the highest point of the spherical object. Due to this tight cavity the spherical object can easily return to the rest position afterwards, if the magnet has lost the grip on the spherical object (for instance after an over-range acceleration or a severe impact). The magnet-spherical object-system acts as a classical spring-mass system, and the spherical object may vibrate slightly around the balance point after a sudden acceleration. Normally this vibration is damped by the friction between the spherical object and the cavity 47 and/or the surrounding air. In order to increase the damping effect, the cavity 47 may be filled with a liquid such as oil. Furthermore, this liquid can protect the spherical object from oxidation. The package 62 may include a flux-closure part 65 as shown in FIG. 6, which shows a second device 40 according to the invention comprising a second sensor arrangement 41 according to the invention in cross section. This flux-closure part 65 will help to increase the magnetic field applied on the field detector 43, thus making the field detector 43 less sensitive to external fields and reducing the stray field of the magnet emitting to the outer side of the sensor arrangement 41.

A third sensor arrangement 41 according to the invention is shown in FIG. 7 in cross section. The movable object 44 now comprises the field generator 42 in the form of a permanent magnet. The fixed object 46 is now made of magnetic material.

A fourth sensor arrangement 41 according to the invention is shown in FIG. 8 in cross section. The movable object 44 now comprises the field generator 42 in the form of a permanent magnet. The fixed object 46 now comprises a further field generator 50 in the form of a further permanent magnet. In the rest position, the magnetic axes are aligned.

A fifth sensor arrangement 41 according to the invention is shown in FIG. 9 in cross section. The cavity 47 comprises elastic material 59 and a movable object 44 comprising the field generator 42 in the form of a permanent magnet. The movable object 44 has a symmetrical shape, whose axis of symmetry being the magnetic axis, such as cylindrical, spherical or prismoid shape. The elastic material is the means for forcing the movable object into a rest position and to counterbalance the parallel component of the force caused by accelerations or gravity. This sensor arrangement 41 can be more compact.

A sixth sensor arrangement 41 according to the invention is shown in FIG. 10 in cross section. The movable object 44 is made of magnetic material and is coupled to a joystick 49 to make a pointing device. The joystick 49 is preferably made of a non-magnetic and light material such as plastic. In the rest position, the joystick stands upright, the magnetic force produced by the permanent magnet is responsible for this. When the device is in use, the joystick 49 can be moved in lateral direction that makes the spherical object roll slightly when sufficient friction is present at the interface, resulting in signal changes on outputs of the field detector 43. Alternatively, the spherical object may be replaced by a half-sphere or only a part of a sphere.

A seventh sensor arrangement 41 according to the invention is shown in FIG. 11 in cross section. The movable object 44 is made of magnetic material and a further movable object 48 can move the movable object 44 in response to an external force to make a pointing device. An example of such a further movable object is a non-magnetic slider placed inside or on top of the package 62 in such a way that it can easily slide in lateral directions. The bottom of the slider may have a concave recess, which is in contact with the upper part of the spherical object. When the slider is moved, e.g. by the finger of a user, the slider can easily drag the spherical object along, resulting in signal changes on the outputs of the field detector 43. Of course, the further movable object 48 may be coupled to and/or comprise the part 42,46.

An eighth sensor arrangement 41 according to the invention is shown in FIG. 12 in cross section. The cavity 47 comprises an inlet 66 and an outlet 67. A gas or a liquid flow sensor arrangement 41 is constructed by forming a channel inside the package 62. The spherical object is placed in the middle of the channel. When a gas or a liquid flows through the channel, the pressure difference between the two sides of the spherical object will displace the spherical object from its rest position. The signal obtained is therefore proportional to the flow of the gas or the liquid. Since the flow is one-dimensional, only one bridge is needed in this case. Preferably, the sensor arrangement is placed in a horizontal position during operation to avoid the influence of gravity. If the sensor arrangement is tilted, its signal should be re-calibrated correspondingly.

Similar to the previous embodiment, a two-dimensional wind sensor can be constructed. In this case, instead of a channel, the cavity 47 is open to all directions. The cap of the package 62 is supported by several small poles in such a way that the two-dimensional flow of air is not affected. The field detector 43 comprises bridges for both the X-direction and the Y-direction as in the two-dimensional acceleration sensor arrangement 41. Horizontally flowing wind slightly moves the spherical object along in the same direction that causes the output signals to change. From the signals, the strength and direction of the wind can be determined. To make the sensor more sensitive, the spherical object size may be enlarged compared to the closed cavity situation and/or the spherical object may be hollow.

A ninth sensor arrangement 41 according to the invention is shown in FIG. 13 in cross section. In this embodiment, a spherical permanent magnet has a rotation axis 68 across its center. The spherical magnet can rotate around the rotation axis 68. The rotation axis 68 of the spherical magnet is perpendicular to its magnetic axis. In the rest position, the magnetic axis of the spherical magnet is aligned to the magnetic axis of the magnet due to the magneto-static coupling. During an angular acceleration measurement, the fictitious torque would rotate the spherical magnet away from the rest position. The balance between the torque induced by the magneto-static coupling and the fictitious torque determines the rotation angle of the spherical magnet, which can be measured via a signal change at the output of the field detector 43. In this case only one bridge is needed because the rotation is only in one direction.

A tenth sensor arrangement 41 according to the invention is not shown but for example shows some similarity with the one shown in FIG. 11. This tenth sensor arrangement is an external force detector for detecting an external force. This external force might be considered to be equivalent to an application of an acceleration in the plane of the elements. This detection can be converted into a size of the external force, under the condition that the angle between the external force and the plane is known and is unequal to 90 degrees. Alternatively, this detection can be converted into an angle of the external force, under the condition that the size of the external force is known and the angle between the external force and the plane is unequal to 90 degrees.

About the field detector 43, the following is to be noted. The field detector 43 shown in FIGS. 1(c) and 1(d) comprises the magneto-resistive elements 51-58. The magneto-resistive elements are elements of which a resistance value depends on an angle θ between a current running in the element and a magnetization M of the element. In case of anisotropic magneto-resistors the resistance R=R₀+ΔR cos²θ in which R is the total resistance value of an element 51-58, R₀ is the base resistance and ΔR/R₀ determines the magneto-resistance effect. The magnetization M within the elements wants to align with the length direction of the elements on the one hand, on the other hand it wants to align with the direction of a magnetic field in which the elements are located. As a result, the magnetization M will take a position between the length direction of the elements and the magnetic field direction. For low magnetic fields it will be closer to the length direction of the elements, for higher magnetic fields it will be closer to the direction of the radial magnetic field. At an infinite high magnetic field, the magnetization M will be aligned with the magnetic field. Thus the resistance value of the elements depends on the a strength and on a direction of the magnetic field. To linearize the transfer curve, Barberpoles strips (shorting bars) made of a non-magnetic conducting material are placed directly on the elements. The shorting bars make an angle β of e.g. (+/−) 45 degrees with the length direction of the elements. The shorting bars deflect the current an angle β with respect to the length direction of the element. That means the current is running perpendicular to the shorting bar directions, thus the resistance in this case becomes R=R₀+ΔR cos²(θ′+β), in which θ′ is the angle between the magnetization M and the length direction of the element. The Barberpole structure in the elements 51-58 in FIGS. 1(c) and 1(d) is arranged such that the angles β of adjacent elements in a Wheatstone bridge have opposite signs. For instance, in the element 51 the angle β is plus 45 degrees whereas in the element 52 the angle β is minus 45 degrees.

A radial magnetic field arises when the magnetic field emanating from the field generator 42 is projected onto the plane of the field detector 43, in other words onto the plane of the elements 51-58. This plane for example comprises the X-axis and the Y-axis. In FIG. 1(c), the centre of the radial magnetic field is in the middle of the elements 51-58 in a rest position of the movable object 44. Due to the radial arrangement of the elements 51-58, the radial magnetic field vectors in the rest position are aligned along the length directions of the elements 51-58, thus forcing the magnetization vectors M parallel to the length directions. According to the above formula, the resistance of the elements 51-58 has the same value of R=R₀+ΔR cos²(β). As a result, the output voltage of a Wheatstone bridge comprising the elements 51-58 is zero.

When the centre of the radial magnetic field is moved from the middle position in FIG. 1(c) to the shifted position in FIG. 1(d) in this X-Y plane, the directions of the radial magnetic fields with respect to the length direction of the elements 51-58 are altered. For example in the elements 51 and 54, the radial field vector moves towards the direction of the current, reducing the angle between the magnetization M and the current and thus increasing the resistance value of the elements 51 and 54. For the elements 52 and 53, the opposite occurs. The radial field vector moves away from the direction of the current, increasing the angle θ between the magnetization M and the current and thus decreasing the resistance value. By properly connecting the elements 51-54 into a bridge configuration, such as a Wheatstone bridge, an output signal can be created which varies approximately linearly with the radial field centre position in the X-direction. For the Y-direction a similar configuration can be made by rotating the complete configuration over 90 degrees. Typically the distance between the elements 51-54 and the radial field centre of the radial component will be much larger (e.g. 300 μm) than typical displacements of that centre (e.g. 20 μm). Therefore, when the radial field centre is displaced mainly the direction of the radial field will be changed and only to a lesser extent the strength of the radial field will be changed.

So, according to FIGS. 1(c) and 1(d), a length axis of a specific magnetic field dependent element for detecting a specific component of the magnetic field should make an angle of substantially zero degree with the specific component for a rest position of the movable object, in case the specific magnetic field dependent element comprises Barberpole strips. An angle of substantially zero degree corresponds with an angle between minus 20 degrees and plus 20 degrees, preferably zero degree. The Barberpole strips are usually oriented at +45 degrees with respect to the length axis of the specific magnetic field dependent element, without excluding other orientations.

Alternatively the elements 51-58 can be constructed without the Barberpole strips as shown in FIGS. 1(f) and 1(g). In this case four strips of magneto-resistive material of a bridge, e.g. the elements 510-540, are placed such that the magnetization M and the length direction of the magneto-resistive elements 51-54 make a certain angle, such as for example an angle of 25-65 degrees, preferably an angle of 45 degrees. If the angle θ is chosen in the neighborhood of 45 degrees, the response characteristic of the element 510-540 will be more or less linear. Best linearity is obtained for 0=45 degrees. By setting the magnetic field under an angle with the length direction of an element 510-540, no Barberpole stripes are required which gives a number of advantages (easier processing, higher resistance, better resistance reproducibility).

When the centre of the radial magnetic field is in the middle of the elements 510-540 in a rest position of the movable object 44 in FIG. 1(f), the angles θ of the four elements 510-540 are equal in magnitude, thus the output voltage of the Wheatstone bridge is zero. When the centre of the radial magnetic field is moved from the middle position in FIG. 1(f) to the shifted position in FIG. 1(g) in this X-Y plane, the directions of the radial magnetic field with respect to the length directions of the elements 510-540 are altered. For example in the elements 520 and 540, the radial field vector moves towards the direction of the current I, reducing the angle between the magnetization M and the current I and thus increasing the resistance value of the elements 520 and 540. For the elements 510 and 530, the opposite occurs. The radial field vector moves away from the direction of the current I, increasing the angle θ between the magnetization M and the current I and thus decreasing the resistance value. By properly connecting the elements 510-540 into a bridge configuration, such as a Wheatstone bridge, an output signal can be created which varies approximately linearly with the radial field centre position in the X-direction. For the Y-direction a similar configuration comprising the elements 550-580 can be made by rotating the complete configuration over 90 degrees.

The acceleration sensor arrangements (41) are widely used in various applications such as automotive (vehicle dynamics control devices, active suspension control devices, headlight leveling system devices, car alarm devices etc.), navigation (mobile phone devices, global positioning system devices etc), appliances (washing machine devices comprising balancing devices etc.), impact/shock detection (detector devices etc.), gaming and robotics (game devices etc., robot devices etc.), data entry for personal digital assistants (handheld devices etc.), earthquake monitoring (monitor devices etc.), human monitoring devices (human monitor devices etc.), antenna azimuth control (antenna control devices etc.) etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A device (40) with a sensor arrangement (41) comprising:
a field generator (42) for generating at least a part of a magnetic field,
a field detector (43) comprising magnetic field dependent elements (51-58) for detecting components of the magnetic field in a plane of the magnetic field dependent elements (51-58), and
a movable object (44) for, in response to an acceleration of the movable object (44), changing the components of the magnetic field,
a length axis of a specific magnetic field dependent element (51-58) for detecting a specific component of the magnetic field making an angle between minus 80 degrees and plus 80 degrees with this specific component.

2. The device (40) according to claim 1, a length axis of the specific magnetic field dependent element (51-58) making an angle of substantially zero degree with the specific component for a rest position of the movable object (44), the specific magnetic field dependent element (51-58) comprising Barberpole strips.

3. The device (40) according to claim 1, a length axis of the specific magnetic field dependent element (51-58) making an angle of substantially 45 degrees with a direction of a magnetization of the specific magnetic field dependent element (51-58) for a rest position of the movable object (44) and for a given strength of the magnetic field.

4. The device (40) according to claim 1, the sensor arrangement (41) further comprising:
means for forcing the movable object (44) into a rest position.

5. The device (40) according to claim 4, the means comprising elastic material (59) for, at least in case of the movable object (44) being in a non-rest position, extending at least one force on the movable object (44) in at least one direction parallel to the plane.

6. The device (40) according to claim 5, the movable object (44) comprising the field generator (42).

7. The device (40) according to claim 4, the means comprising a fixed object (46), one of the objects comprising the field generator (42) and the other object comprising magnetic material.

8. The device (40) according to claim 7, the movable object (44) being in the form of a sphere located in a cavity (47).

9. The device (40) according to claim 8, the cavity (47) comprising a liquid.

10. The device (40) according to claim 8, the cavity (47) comprising an inlet (66) and an outlet (67).

11. The device (40) according to claim 7, the movable object (44) being coupled to a joystick (49).

12. The device (40) according to claim 7, the sensor arrangement (41) further comprising:
a further movable object (48) for, in response to an external force, moving the movable object (44).

13. The device (40) according to claim 7, the sensor arrangement (41) being an external force detector.

14. The device (40) according to claim 7, the other object comprising the magnetic material being a further field generator (50) for generating at least a further part of the magnetic field.

15. A sensor arrangement (41) comprising:
a field generator (42) for generating at least a part of a magnetic field,
a field detector (43) comprising magnetic field dependent elements (51-58) for detecting components of the magnetic field in a plane of the magnetic field dependent elements (51-58), and
a movable object (44) for, in response to an acceleration of the movable object (44), changing the components of the magnetic field,
a length axis of a specific magnetic field dependent element (51-58) for detecting a specific component of the magnetic field making an angle between minus 80 degrees and plus 80 degrees with this specific component.

16. A sensing method comprising the steps of:
generating at least a part of a magnetic field,
detecting components of the magnetic field via magnetic field dependent elements (51-58) in a plane of the magnetic field dependent elements (51-58), and
in response to an acceleration of a movable object (44), changing the components of the magnetic field,
a length axis of a specific magnetic field dependent element (51-58) for detecting a specific component of the magnetic field making an angle between minus 80 degrees and plus 80 degrees with this specific component.
